(19) United States
(12) Patent Application Publication
(10) Pub. No.: US 2023/0240458 A1
(43) Pub. Date: Aug. 3, 2023

(54) Infant Neck Rest

(71) Applicant: Dawn Alva, Las Vegas, NV (US)

(72) Inventor: Dawn Alva, Las Vegas, NV (US)

(21) Appl. No.: 17/590,696

(22) Filed: Feb. 1, 2022

(51) Int. Cl. A47G 9/10

(52) U.S. Cl. CPC A47G 9/1081

(57) ABSTRACT

The disclosure, also known as the Comfee nap is the only product of its kind that has the capability of clearing the child’s airway and includes a plush and supportive neck pillow for sleeping that is able to complement any stroller design. This avant-garde product is uniquely comprised with adequate mesh support and a durable Velcro(copyright) attachment to ensure long term sustainability. Moreover, the Comfee nap comes in a wide variety of different colors and sizes and provides the ultimate comfort accessory for all toddlers.

### BACKGROUND

When it comes to child care and transporting toddlers in a stroller, it is very common for them to fall asleep while they are within the accessory. This upright sleeping position can not only be uncomfortable for the child but may also pose serious risks as the child’s neck and head placement, while sitting, is not ideal from a body safety standpoint. There have been no products available as original equipment or as an aftermarket to address this problem.

An apparatus to protect a child’s neck and head placement while in a stroller is not being met by any known device or system at present. There have been no products available as original equipment or as an aftermarket to address this problem either.

### SUMMARY OF THE INVENTION

The main purpose of the infant neck rest is to provide users with a toddler neck support cushion intended to be used in complement with strollers.

### BRIEF DESCRIPTION OF THE DRAWINGS

FIG. 1 is a top perspective view of the infant neck rest in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

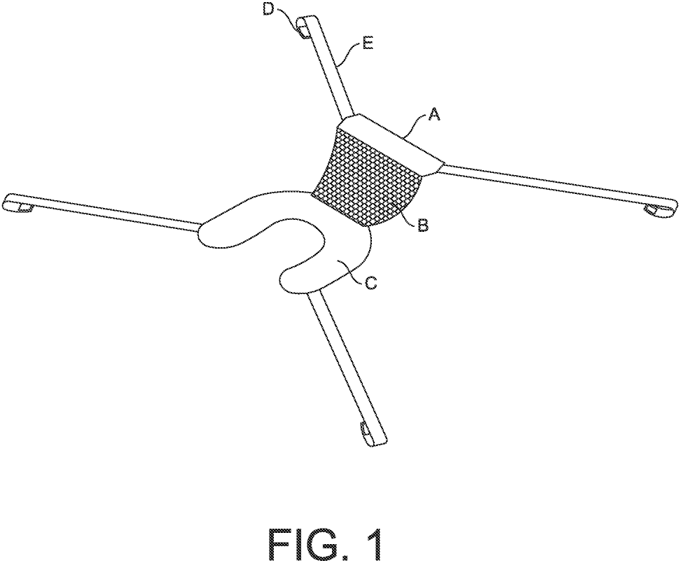

FIG. 1 is a top perspective view of the infant neck rest showing: top cover referenced as A, mesh support referenced as B, neck pillow referenced as C, Velcro attachment to stroller pole referenced as D, strap referenced as E, in accordance with an embodiment of the present disclosure.

The present disclosed infant neck rest, also known as the “Comfee Nap” offers a novel padding that serves to provide great neck and head support for sleepy babies and kids, by preventing their head from falling to the side while sleeping in their stroller and therefore allowing for a more restful, comfortable, and safe sleep. Expanding on the initial design of an average stroller, the Comfee nap introduces a novel portable neck pillow that straps to the side of the stroller and has a mesh net that supports an infants’ head. The Comfee nap forms a hammock around a child’s neck which cradles their head instead of letting it droop uncomfortably. To further enhance functionality, this top-quality product can be easily attached to different levels of the side of the stroller to cater specifically to the child’s size; yet, the primary cushion still permits freedom of head movement, in the front, while also assisting in clearing the child’s airway thus giving them the opportunity to sleep comfortably should they fall asleep as they are being pushed in a wheeled carriage. This unprecedented product may benefit all parents who seek to create a more comfortable and safe sleeping environment for their children while in their strollers.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. An infant neck rest comprising:
a neck pillow comprising two ends and a back connecting the two ends;
a material support attached to the back of the neck pillow along a bottom edge thereof and comprising a top edge opposite thereto and lateral edges there between; and
a strap attached to each of the two ends and a strap attached to the top edge of the material support,
wherein the straps are configured to secure the material support around a stroller handle.

2. The infant neck rest of claim 1, wherein each of the straps comprise a hook and a loop attachment.

3. The infant neck rest of claim 1, wherein the material support is configured to cradle a head of an infant.

4. The infant neck rest of claim 1, wherein the strap attached to the top edge is attached to a corner of the back edge.

5. The infant neck rest of claim 4, further comprising another strap attached to another corner of the top edge.

6. The infant neck rest of claim 1, wherein the material support comprises a mesh fabric adapted to cradle an infant’s head therein.

7. The infant neck rest of claim 1, wherein the top edge further comprises a stiff material configured to maintain a distance between a first corner and a second corner thereof.

8. The infant neck rest of claim 1, wherein the straps are each configured to wrap around the stroller handle.

9. The infant neck rest of claim 1, wherein the neck pillow is configured in a “U” shaped design comprising two leg ends and a back connecting the two leg ends.

10. The infant neck rest of claim 1, wherein the material support comprises a “V” shape from the bottom edge configured narrow in relation the top edge.

11. The infant neck rest of claim 1, further comprising a suspension seam along each of the lateral edges of the material support between the top edge and the back of the neck pillow.
